(19) United States
(12) Patent Application Publication
(10) Pub. No.: US 2026/0258791 A1
(43) Pub. Date: Sep. 3, 2026

(54) A RADIATOR MODULE FOR A CONDITIONING SYSTEM OF A WIND TURBINE

(71) Applicant: Vestas Wind Systems A/S, Aarhus N. (DK)

(72) Inventor: Erik Markussen, Videbæk (DK)

(73) Assignee: Vestas Wind Systems A/S, Aarhus N. (DK)

(21) Appl. No.: 18/877,612

(22) PCT Filed: Jun. 16, 2023
(86) PCT No.: PCT/DK2023/050149

§ 371 Date: Dec. 20, 2024

(30) Foreign Application Priority Data
Jun. 28, 2022 (DK) PA202270343

(51) Int. Cl. F03D 80/60

(52) U.S. Cl. CPC F03D 80/60; F05B 2260/20

(57) ABSTRACT

A radiator module (3) for a conditioning system of a wind turbine is disclosed. The radiator module (3) comprises a frame (6) configured to support one or more radiator elements (4), and at least one mounting element (5) establishing a mounting interface between the radiator module (3) and a structural part of a wind turbine having the conditioning system mounted thereon. The at least one mounting element (5) is attached to the frame (6). The frame (6) is provided with at least two predefined attachment positions (11), each being adapted to have a mounting element (5) attached thereto. The radiator module (3) is thereby configurable to match a variety of wind turbine models by selectively attaching a mounting element (5) to each selected attachment position (11) selected among the at least two predefined attachment positions (11).

### FIELD OF THE INVENTION

The present invention relates to a radiator module for a conditioning system, such as a cooling system, for a wind turbine. The present invention further relates to a conditioning system comprising at least one such radiator module and to a method for configuring a radiator for such a conditioning system. The radiator module of the invention allows the conditioning system to be configured in accordance with a range of different wind turbine models or types.

### BACKGROUND OF THE INVENTION

Wind turbines often need to be conditioned, e.g. in order to keep the temperature of various components, lubricating oil, hydraulic fluids and/or interior spaces of the wind turbine, such as inside the nacelle, within an acceptable temperature range. To this end, the wind turbine may be provided with a conditioning system comprising a number of heat exchangers. The conditioning system may comprise one or more panels which are arranged outside the wind turbine, e.g. on top of the nacelle. In this case each panel carries one or more radiators which reject heat from the conditioning system to the ambient air via heat exchange.

The panels described above need to be mounted on the nacelle of the wind turbine in a secure and safe manner. In order to ensure this, mounting elements of the panels may be attached to structural support points in the nacelle. The nature and the positions of appropriate structural support points varies from one type of wind turbine to another. Therefore, it is necessary to design the panels specifically for use in a certain type of wind turbine. Accordingly, a manufacturer of conditioning systems for wind turbines might need to manufacture a wide range of different panels, in order to be able to provide conditioning systems for various types of wind turbines.

### DESCRIPTION OF THE INVENTION

It is an object of embodiments of the invention to provide a radiator module for a conditioning system of a wind turbine, which is configurable to match a variety of wind turbine models or types.

It is a further object of embodiments of the invention to provide a conditioning system for a wind turbine, which is configurable to match a variety of wind turbine models or types.

According to a first aspect the invention provides a radiator module for a conditioning system of a wind turbine, the radiator module comprising:
a frame configured to support one or more radiator elements, and
at least one mounting element configured for establishing a mounting interface between the radiator module and a structural part of a wind turbine having the conditioning system mounted thereon, the at least one mounting element being attached to the frame, wherein the frame is provided with at least two predefined attachment positions, each being adapted to have a mounting element attached thereto, the radiator module thereby being configurable to match a variety of wind turbine models by selectively attaching a mounting element to each selected attachment position selected among the at least two predefined attachment positions.

Thus, the first aspect of the invention relates to a radiator module for a conditioning system of a wind turbine. In the present context the term ‘conditioning system’ should be interpreted to mean a system which is used for conditioning the wind turbine, in particular with regard to maintaining temperatures of components, fluids and/or interior spaces of the wind turbine within an acceptable temperature range.

In the present context the term ‘radiator module’ should be interpreted to mean a part of the conditioning system which rejects or radiates heat from the conditioning system to the ambient.

The radiator module comprises a frame configured to support one or more radiator elements. The one or more radiator elements form the part of the radiator module which actually rejects or radiates heat from the conditioning system to the ambient. Each radiator module may, thus, comprise at least one heat exchanger.

The radiator module further comprises at least one mounting element. The at least one mounting element establishes an interface between the radiator module and a structural part of a wind turbine having the conditioning system mounted thereon. Accordingly, when the radiator module is mounted on a wind turbine, as part of a conditioning system, it is attached to the wind turbine by means of the at least one mounting element being attached to at least one structural part of the wind turbine.

The at least one mounting element is attached to the frame. Thereby each mounting element interconnects the frame and a structural part of the wind turbine when the radiator module is mounted on the wind turbine.

The frame is provided with at least two predefined attachment positions. Each predefined attachment position is adapted to have a mounting element attached thereto. Accordingly, a given mounting element may be attached to the frame at any one of the predefined attachment positions. Thus, the position of a given mounting element relative to the frame may be selected by selecting the predefined attachment position where the mounting element is to be attached to the frame.

Thereby the radiator module is configurable to match a variety of wind turbine models or types, simply by selecting at least one appropriate attachment position among the at least two predefined attachments positions, and selectively attaching a mounting element to each selected attachment position. This allows that each mounting element is positioned relative to the frame in such a manner that a connection can readily be established between the mounting elements and appropriate structural parts of the wind turbine. In the present context the term ‘structural part’ should be interpreted to mean a part of the wind turbine which is capable of taking up loads. Accordingly, the structural parts of the wind turbine are suitable for having structures, such as a mounting element of a radiator module, attached thereto.

Accordingly, conditioning systems can be configured to match a variety of different wind turbine models or types, based on a very limited number of parts, and without having to prepare special designs for each wind turbine model or type. This reduces the manufacturing costs significantly.

Each mounting element may comprise a leg being adapted to form the connection to the structural part of the wind turbine, and the leg may have an adjustable length.

According to this embodiment, it is a portion of the leg which is attached to the structural part of the wind turbine when the radiator module is mounted on the wind turbine. Since the length of the leg is adjustable, a distance between the frame and the portion which is attached to the structural part of the wind turbine can be adjusted. Accordingly, this distance can be adjusted to match a distance between a position on the wind turbine where the frame should be positioned and a position of a structural part of the wind turbine to which the mounting element may suitably be attached. This makes the radiator module even more flexible and allows the conditioning system to be mounted on an even wider variety of wind turbine models or types.

The mounting element may comprise a guiding fixture configured for attachment to the frame at a selected attachment position, and the guiding fixture may comprise a guideway into which the leg can slide in its longitudinal direction and be fixed at a position, such that the length of the leg outside the frame can be set.

According to this embodiment, the length of the leg is adjusted by sliding the leg along the guideway until a desired length has been obtained. Then the leg is fixed at that position, e.g. by means of a suitable locking mechanism which prevents further relative movement between the leg and the guideway. Thereby it is prevented that the length of the leg is accidentally adjusted after the radiator module has been mounted on a wind turbine, and possibly also during the mounting of the radiator module on the wind turbine.

Adjusting the length of the leg by sliding it along the guideway is an easy manner of adjusting the length. Furthermore, the movements of the leg relative to the frame are restricted to a single direction, defined by the guideway, and thereby the adjustment of the length of the leg is performed in a well defined and controlled manner.

The radiator module may further comprise at least one support arm, each configured for establishing a support connection between the radiator module and a wind turbine having the conditioning system mounted thereon, wherein the frame may be provided with at least two predefined support positions, each being adapted to have a support arm attached thereto, wherein the at least one support arm may interconnect one of the at least two predefined support positions and a connection position at a structural part of the wind turbine, the connection position being arranged at a distance in front of or behind the frame, the at least one support arm thereby extending along a direction forming an angle relative to the frame, the support arm thereby being adapted to take up forces in a direction transversely to the frame.

According to this embodiment, at least one support arm is provided for establishing at least one support connection between the radiator module and a wind turbine having the conditioning system mounted thereon. Thereby the radiator module is mounted on the wind turbine in a more firm and secure manner.

Similarly to the mounting elements described above, the at least one support arm is also attached to the frame in a manner which allows the radiator module to be configured to match a variety of wind turbine models or types, by selectively attaching support arms to support positions on the frame selected from the at least two predefined support positions.

The connection position at the structural part of the wind turbine which the support arm is connected to is arranged at a distance in front of or behind the frame. Thereby the support arm extends from the support position on the frame towards the connection position at the structural part, along a direction which forms an angle relative to the frame. This allows the support arm to take up forces in a direction transversely to the frame. Thereby the at least one support arm supports and stabilises the radiator module in a transverse direction.

In an embodiment of the invention, the support position on the frame is arranged such the angle relative to the frame is between 30° to 60°, more preferred 40° to 50° or most preferred at approximately 45°.

Lower angles reduce the forces (tension and compression) in the support arm for a given support of the frame, and higher angles increase the forces in the support arm for a given support of the frame. Thus, for a low angle, the support arm may require less material in its cross section compared to a support arm for a higher angle. On the other hand, the support arm of a lower angle will be longer than for a higher angle. The angles between 40° to 50°, and most preferred at approximately 45°, provides the best compromise, resulting in the least material used, and thereby lowest weight of the support arm.

The at least one support arm may have an adjustable length. According to this embodiment, the length of the support arm can be adjusted to match a distance between the frame of the radiator module and a suitable connection position at the wind turbine, thereby allowing the radiator module to be configurable to match a wider variety of wind turbine models or types. This is similar to the adjustable leg of the mounting element described above.

The at least one support arm may be attached to the frame via a hinge connection. According to this embodiment, the angle defined between the support arm and the frame may be adjusted by means of the hinge connection, in order to match the position of a relevant connection position at a structural part of the wind turbine. Furthermore, the hinge connection may allow the support arm to be folded along the frame during transport, thereby minimising space required for the radiator module during transport, and moved to a relevant angle during mounting of the radiator module on the wind turbine.

The frame may further be provided with at least one interface part being adapted to form a frame-to-frame connection to an adjacent radiator module according to the first aspect of the invention.

According to this embodiment, the frames of at least two adjacent radiator modules may be connected to each other, via their respective interface parts.

Thereby the radiator modules in combination will form a radiator with a desired and appropriate capacity for a conditioning system of a wind turbine. The radiator may be constructed by selecting and configuring a number of radiator modules which provide the desired capacity and connecting these to each other to form the radiator. Accordingly, radiators for a range of wind turbine models and variants can be easily configured using radiator modules according to the invention, and the radiator may be regarded as having a modular design. The radiator modules being connected to each other may, e.g., be substantially identical.

The at least one frame interface part may be configured for attachment to any of the at least two predefined attachment positions. According to this embodiment, the at least two predefined attachment positions may be applied for attaching a mounting element to the frame, as well as for connecting the frame to a frame of another radiator module. Accordingly, the predefined attachment positions may be regarded as multi-purpose interfaces, which may each have a mounting element and/or a frame of another radiator module attached thereto.

For instance, the predefined attachment positions may be or comprise through-going holes formed in the frame. In this case the through-going holes may be configured to receive a bolt or a similar attachment means for fixing a mounting element or a frame of another radiator module to the frame.

The radiator module may comprise at least two radiator elements and fluid connections for fluidly interconnecting the at least two radiator elements.

According to this embodiment, at least two radiator elements are mounted on the frame, and the at least two radiator elements are fluidly connected to each other by means of the fluid connections. Thereby the at least two radiator elements effectively form a single large radiator element, with the same heat exchanging fluid flowing therethrough. This modular design allows the radiator module to be configured with a desired radiator capacity, simply by selecting an appropriate number of radiator elements and fluidly connecting these to each other.

The fluid connections may, e.g., be in the form of interconnecting pipes.

According to a second aspect the invention provides a conditioning system for a wind turbine, the conditioning system comprising at least one radiator module according to the first aspect of the invention.

Since the conditioning system according to the second aspect of the invention comprises at least one radiator module according to the first aspect of the invention, the remarks set forth above with reference to the first aspect of the invention are equally applicable here. Accordingly, the conditioning system according to the second aspect of the invention is flexible in the sense that it can be configured to match the designs of a variety of different wind turbine models or types.

The conditioning system may comprise at least two radiator modules, and the radiator elements of the at least two radiator modules may be fluidly coupled to each other. Thereby radiator elements of the at least two radiator modules effectively form a single large radiator, similarly to the embodiment described above where at least two radiator elements of a single radiator module were fluidly connected to each other.

According to a third aspect the invention provides a method for configuring a radiator of a conditioning system for a wind turbine with a nacelle defining structural support points for the radiator, the method comprising the steps of:
defining thermal requirements of the radiator,
based on the defined thermal requirements, defining a number of radiator elements and a number of radiator modules according to the first aspect of the invention necessary in order to meet the defined thermal requirements,
providing, as defined, at least one radiator element and at least one radiator module according to the first aspect of the invention,
configuring the at least one radiator module by performing the steps of:
   selectively attaching a mounting element to each selected attachment position, selected among the at least two predefined attachment positions, where the selected attachment positions match positions of structural support points of the nacelle, and
   mounting at least one radiator element on the provided radiator modules, and
mounting the at least one radiator module on the nacelle of the wind turbine by attaching the at least one mounting element to the corresponding structural support points of the nacelle.

A person skilled in the art would readily recognise that any feature described in combination with the first or second aspect of the invention could also be combined with the third aspect of the invention, and vice versa.

The method according to the invention is a method for configuring a radiator of a conditioning system for a wind turbine. The conditioning system may be a conditioning system according to the second aspect of the invention, and the radiator may comprise at least one radiator module according to the first aspect of the invention. Thus, the remarks set forth above are equally applicable here.

The wind turbine comprises a nacelle defining structural support points for the radiator. As described above, such structural support points are capable of taking up loads, and they are therefore suitable for having structures attached thereto.

In the method according to the third aspect of the invention, thermal requirements of the radiator are initially defined. In the present context the term ‘thermal requirements’ should be interpreted to mean required specifications of the radiator in terms of transferring heat, in order to meet the conditioning requirements of the wind turbine, under the expected operating conditions at the site where the wind turbine Is positioned or is supposed to be positioned.

Thus, by defining the thermal requirements of the radiator, a measure for the required heat exchanging capacity of the radiator is obtained.

Based on the defined thermal requirements, a number of radiator elements and a number of radiator modules, which are needed in order to meet the defined thermal requirements, are then defined. The radiator modules carrying the radiator elements are of the kind described above with reference to the first aspect of the invention.

The heat exchanging capacity of each radiator element is known. It is also known how many radiator elements each radiator module is able to accommodate. Furthermore, it is known how many radiator modules it is possible to mount on the wind turbine. Based on this knowledge, a combination of radiator modules and radiator elements can be selected, which match the thermal requirements of the wind turbine, and which it is possible to mount on the wind turbine.

The defined number of radiator elements and radiator modules are then provided, and at least one radiator module is configured in the following manner.

At least one attachment position on the frame of the radiator module is selected among the at least two predefined attachment positions. The at least one attachment position is selected in such a manner that it matches corresponding at least one position of corresponding structural support points of the nacelle. A mounting element is then attached to the frame at each of the selected attachment positions. Thereby the radiator module is provided with at least one mounting element positioned in such a manner that a connection can readily be established between the radiator module and at least one structural support point in the nacelle of the wind turbine.

Furthermore, at least one radiator element is mounted on each of the at least one radiator module, thereby ensuring that the at least one radiator module actually meets the thermal requirements of the wind turbine.

Finally, the at least one radiator module is mounted on the nacelle of the wind turbine by attaching the at least one mounting element to the corresponding structural support points of the nacelle.

Each mounting element may comprise a leg with an adjustable length being adapted to be connected to the structural support points of the nacelle of the wind turbine, and the method may further comprise the step of adjusting the length of each leg in accordance with the position of the corresponding structural support point of the nacelle.

This has already been described above with reference to the first aspect of the invention.

The at least one radiator module may comprise at least one support arm, each configured for establishing a support connection between the radiator module and the wind turbine, wherein the frame may be provided with at least two predefined support positions, each being adapted to have a support arm attached thereto, and the method may further comprise mounting the at least one support arm at one of the at least two predefined support positions and at a connection position at a structural support point of the nacelle, the connection position being arranged at a distance in front of or behind the frame, the at least one support arm thereby extending along a direction forming an angle relative to the frame, the support arm thereby being adapted to take up forces in a direction transversely to the frame.

This has already been described above with reference to the first aspect of the invention.

The step of providing at least one radiator module may comprise providing at least two radiator modules, and the method may further comprise the step of forming frame-to-frame connections between the at least two radiator modules via at least one interface part formed on the frames of the at least two radiator modules.

This has already been described above with reference to the first aspect of the invention.

The radiator being composed through this method, preferably exceeds the thermal requirements of a wind turbine by some amount. The availability of radiator modules provides a thermal performance of a radiator in increments according to the number and configuration of the radiator modules selected. Therefore, in a range of turbine models and variants using the radiator according to this invention the wind turbines will have a performance that deviates from an optimal radiator for a specific turbine. However, the benefit of reduced development costs, reduced cost of inventory and the availability of radiator modules for maintenance and replacement outweighs installing radiators that may be oversized for a given wind turbine.

According to a fourth aspect the invention provides a wind turbine comprising at least one radiator module according to the first aspect of the invention.

Since the wind turbine according to the fourth aspect of the invention comprises at least one radiator module according to the first aspect of the invention, the remarks set forth above with reference to the first aspect of the invention are equally applicable here.

### BRIEF DESCRIPTION OF THE DRAWINGS

The invention will now be described in further detail with reference to the accompanying drawings in which

FIGS. 1 and 2 illustrate a radiator comprising two radiator modules according to an embodiment of the invention mounted on a nacelle of a wind turbine,

FIGS. 3-5 illustrate a radiator module according to a first embodiment of the invention,

FIG. 6 illustrates a radiator module according to a second embodiment of the invention,

FIGS. 7 and 8 illustrate a radiator module according to a third embodiment of the invention, and

FIGS. 9 and 10 illustrate a radiator module according to an embodiment of the invention during transport.

### DETAILED DESCRIPTION OF THE DRAWINGS

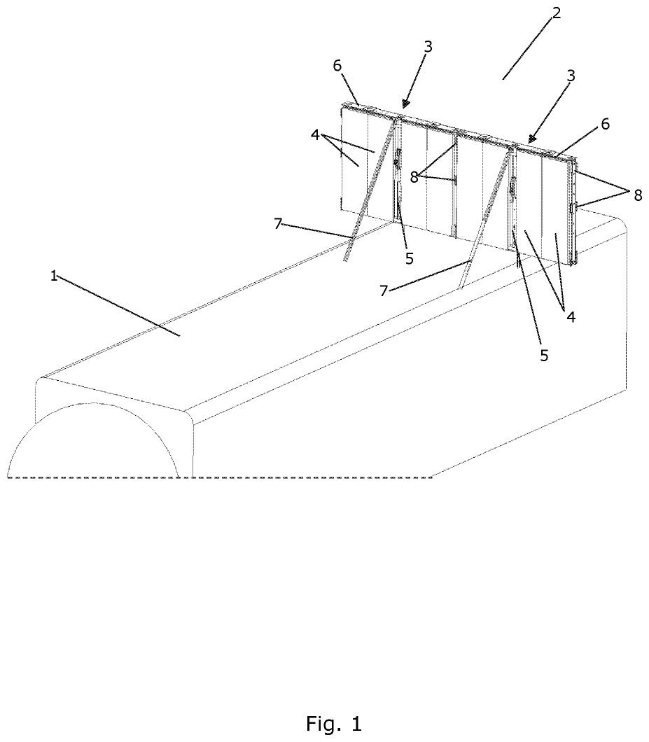

FIG. 1 illustrates a nacelle 1 of a wind turbine having a radiator 2 mounted thereon. The radiator 2 comprises two radiator modules 3, each carrying four radiator elements 4.

Each radiator module 3 is provided with a mounting element 5 which is attached to a frame 6 of the radiator module 3 at a predefined attachment position. The predefined attachment positions are selected in such a manner that they match positions of structural support points (not visible) arranged inside the nacelle 1, in the sense that a leg (not visible) of each mounting element 5 can readily be attached to a suitable structural support point.

Each radiator module 3 is further provided with a support arm 7 extending from a support position on the frame 6 along a direction which forms an angle with respect to the frame 6. The free end of each support arm 7 is connected to a suitable structural support point (not shown) arranged inside the nacelle 1 at a position in front of the radiator module 3. The support arms 7 provide support for the radiator modules 3 by taking up forces in a direction transversely to the frames 6 of the radiator modules 3, due to their angled position relative to the radiator modules 3.

The radiator modules 3 are connected to each other via interface parts 8. Furthermore, fluid connections (not shown) interconnect the radiator elements 4 of both radiator modules 3.

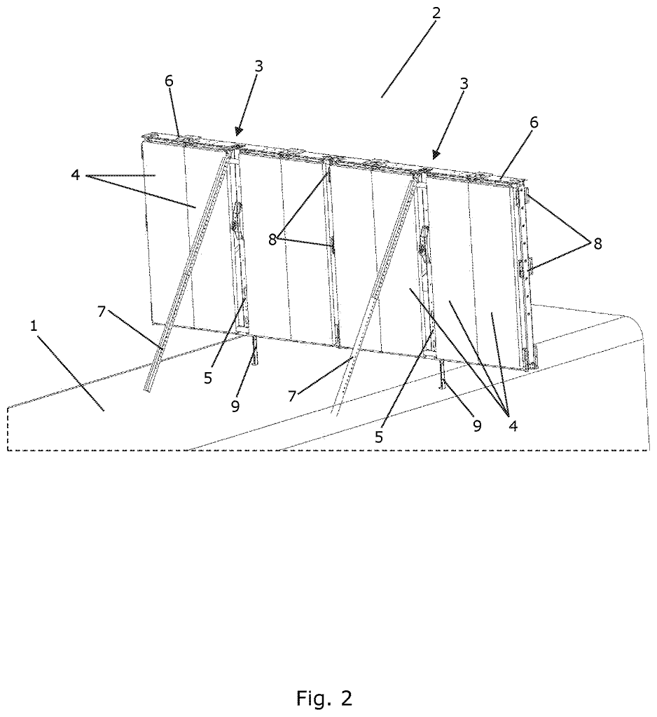

FIG. 2 is a detailed view of the radiator 2 of FIG. 1. In FIG. 2 the nacelle 1 is transparent, thereby allowing the legs 9 of the mounting elements 5 to be seen. The legs 9 are arranged slidingly relative to a part of the corresponding mounting element 5 which is attached to the frame 6. Thereby the length of each leg 9 can be adjusted to match a distance between the radiator module 3 and a relevant structural support point inside the nacelle 1.

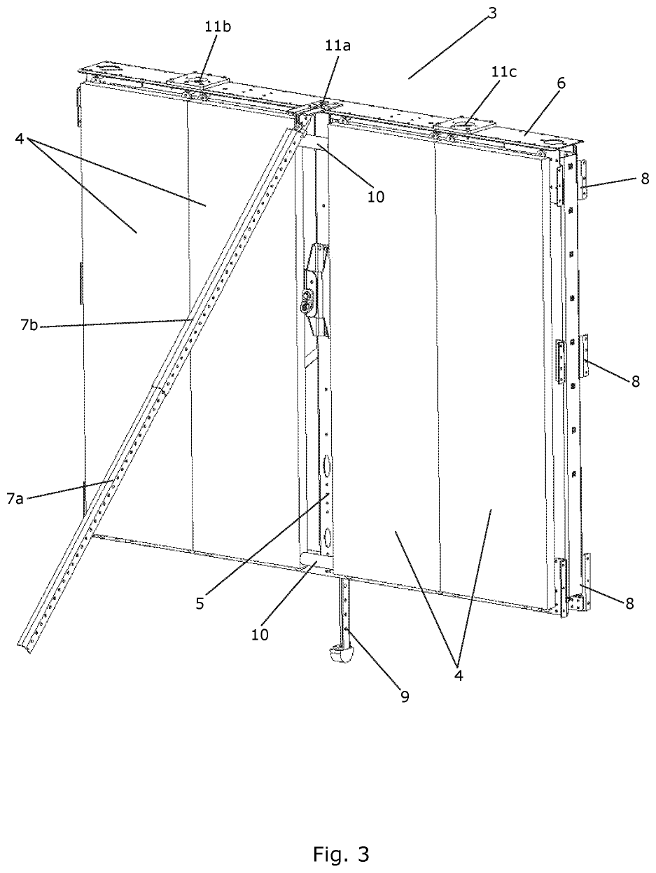

FIG. 3 is a perspective view of a radiator module 3 according to a first embodiment of the invention. The radiator module 3 shown in FIG. 3 is identical to the radiator modules 3 shown in FIGS. 1 and 2, and it will therefore not be described in detail here.

In FIG. 3, it can be seen that fluid connections 10 in the form of pipes interconnect the radiator elements 4. It can also be seen that the support arm 7 comprises a first part 7a and a second part 7b arranged slidingly relative to each other, thereby allowing the length of the support arm 7 to be adjusted, similarly to the adjustment of the legs 9 of the mounting elements 5.

In the embodiment of FIG. 3, the mounting element 5 is attached to the frame 6 at an attachment position 11a, which is arranged substantially halfway between side portions of the frame 6, and thereby with two radiator elements 4 arranged on each side of the mounting element 5. Two further attachment positions 11b, 11c are predefined on the frame 6, thereby allowing the radiator module 3 to be configured in a different manner by attaching a mounting element at attachment position 11b and/or at attachment position 11c, as an alternative or in addition to the mounting element 5 being attached at attachment position 11a.

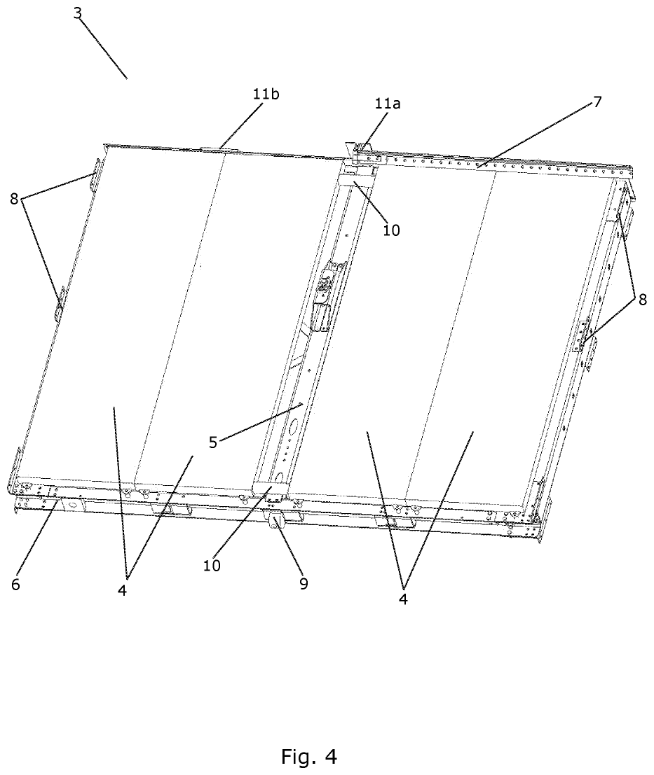

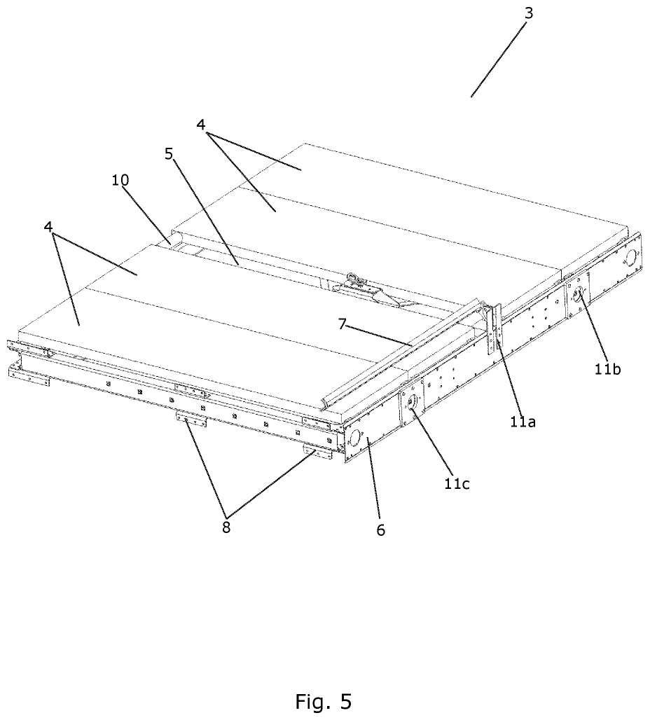

FIGS. 4 and 5 show the radiator module 3 of FIG. 3 in a configuration which is suitable for transport of the radiator module 3. It can be seen that the support arm 7 has been folded to a position along the frame 6, thereby allowing radiator modules 3 to be stacked and minimising space requirements during transport.

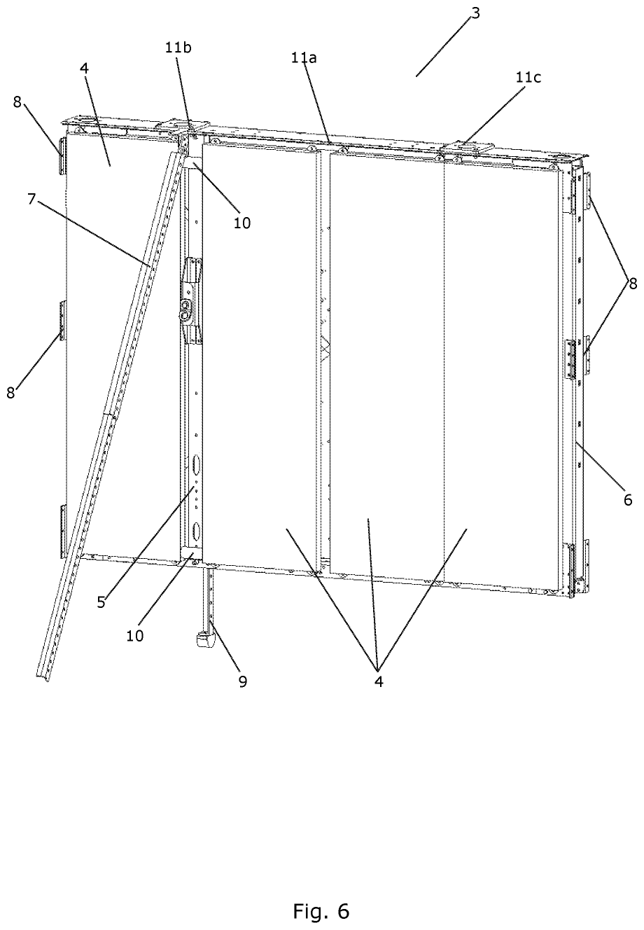

FIG. 6 is a perspective view of a radiator module 3 according to a second embodiment of the invention. The radiator module 3 of FIG. 6 is very similar to the radiator module 3 of FIGS. 3-5, and therefore only the differences will be described in detail here.

In the radiator module 3 of FIG. 6, the mounting element 5 is attached to the frame 6 at attachment position 11b, rather than at attachment position 11a. Thereby the mounting element 5 is arranged asymmetrically with respect to the side portions of the frame 6, and with one radiator element 4 at one side of the mounting element 5 and three radiator elements 4 at the other side of the mounting element 5. Accordingly, the mounting element 5 is positioned in a manner which matches the position of a structural support part in a wind turbine of a different model or type than the one shown in FIGS. 1 and 2.

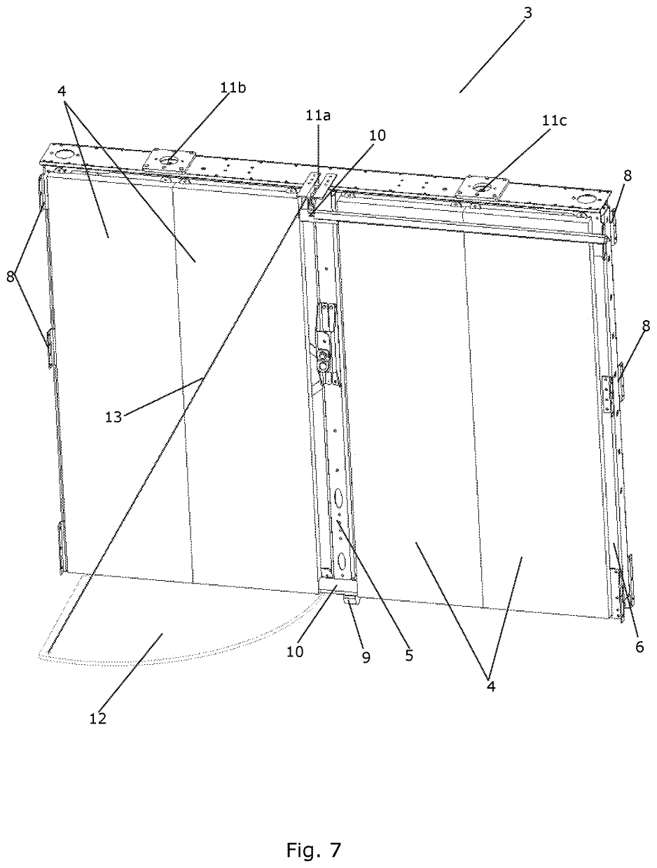

FIG. 7 is a perspective view of a radiator module 3 according to a third embodiment of the invention. The radiator module 3 of FIG. 7 is similar to the radiator module 3 of FIGS. 3-5, and therefore only the differences will be described in detail here.

The radiator module 3 of FIG. 7 is provided with a service platform 12 mounted pivotally on the frame 6, thereby allowing the service platform 12 to be rotated between an extended operating position and a stowed position. In FIG. 7, the service platform 12 is in the extended operating position, allowing service personnel to stand on the service platform 12 in order to perform maintenance on the radiator module 3.

The service platform 12 is further connected to the frame 6 at the attachment position 11a via a wire 13. When the service platform 12 is rotated to the extended operating position, as shown in FIG. 7, the wire 13 is tightened, thereby providing support for the service platform 12, allowing it to carry a person.

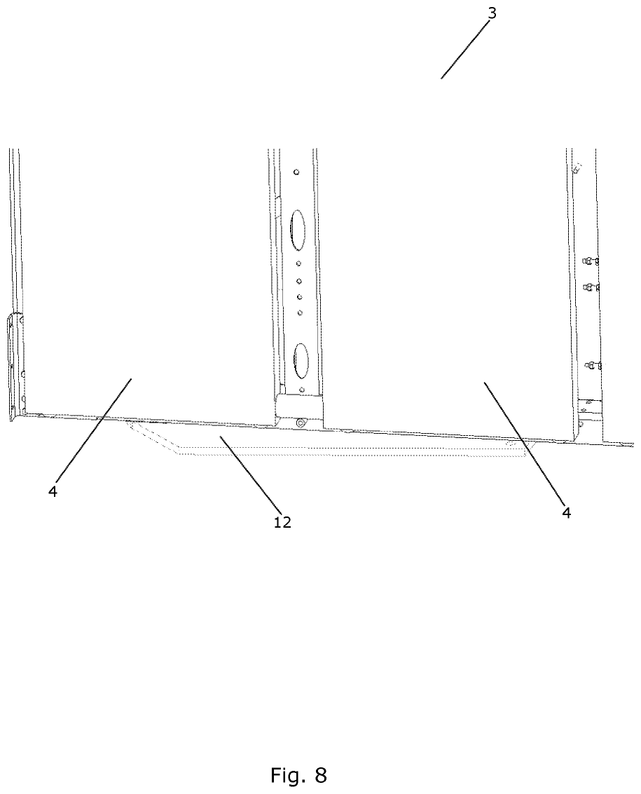

FIG. 8 shows a detail of the radiator module 3 of FIG. 7, with the service platform 12 in the stowed position.

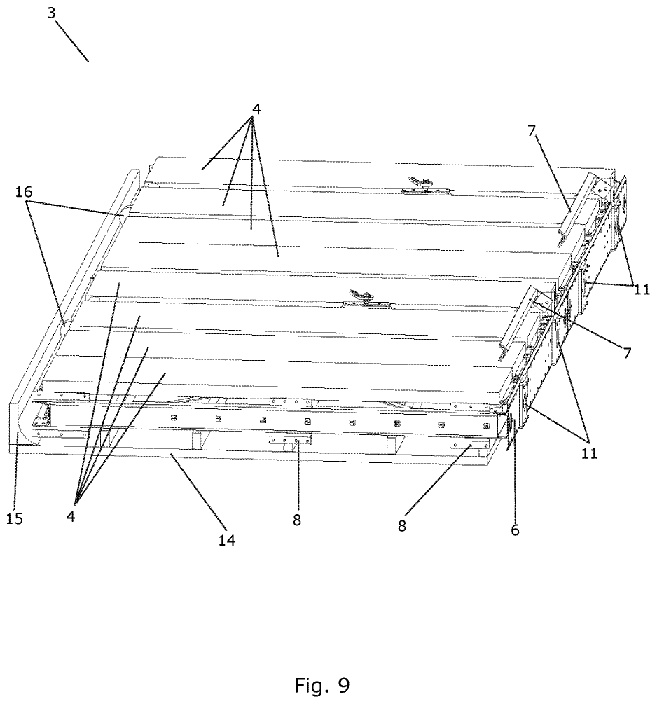

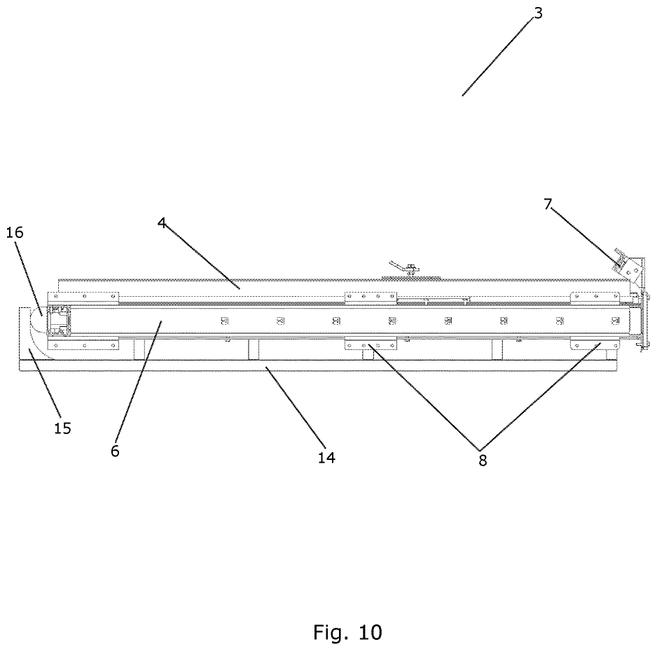

FIGS. 9 and 10 illustrate a radiator module 3 according to an embodiment of the invention during transport. FIG. 9 is a perspective view of the radiator module 3, and FIG. 10 is a side view of the radiator module 3.

The radiator module 3 comprises a frame 6 having eight radiator elements 4 mounted thereon. Two support arms 7 are attached to the frame 6 and folded along the radiator module 3 for easy transport.

A transportation frame 14 is provided in which the radiator module 3 can be transported safely. The transportation frame 14 has an end beam 15 with a curved surface. Transportation feet 16 are attached to the radiator module 3 and the transportation feet 16 are resting against the sloped surface of the end beam 15. When the radiator module 3 is lifted out of the transportation frame 14, a lifting arrangement (not shown) is attached to lifting points on the top of the radiator module 3, for example the attachment positions 11. As the radiator module 3 rotates from a horizontal orientation to a vertical orientation, the transportation feet 16 ensure that the bottom of the radiator module 3 does not touch the transportation frame 14, thereby avoiding damage to the radiator module 3.

The transportation feet 16 may be removed before installation of the radiator module 3 on the nacelle 1.

1. A radiator module for a conditioning system of a wind turbine, the radiator module comprising:
a frame configured to support one or more radiator elements, and
at least one mounting element configured for establishing a mounting interface between the radiator module and a structural part of a wind turbine having the conditioning system mounted thereon, the at least one mounting element being attached to the frame,
wherein the frame is provided with at least two predefined attachment positions, each being adapted to have a mounting element attached thereto, the radiator module thereby being configurable to match a variety of wind turbine models by selectively attaching a mounting element to each selected attachment position selected among the at least two predefined attachment positions.

2. The radiator module according to claim 1, wherein each mounting element comprises a leg being adapted to form the connection to the structural part of the wind turbine, wherein the leg has an adjustable length.

3. The radiator module according to claim 2, wherein the mounting element comprises a guiding fixture configured for attachment to the frame at a selected attachment position, wherein the guiding fixture comprises a guideway into which the leg can slide in its longitudinal direction and be fixed at a position, such that the length of the leg outside the frame can be set.

4. The radiator module according to claim 1, further comprising at least one support arm, each configured for establishing a support connection between the radiator module and a wind turbine having the conditioning system mounted thereon, wherein the frame is provided with at least two predefined support positions, each being adapted to have a support arm attached thereto, wherein the at least one support arm interconnects one of the at least two predefined support positions and a connection position at a structural part of the wind turbine, the connection position being arranged at a distance in front of or behind the frame (6), the at least one support arm thereby extending along a direction forming an angle relative to the frame, the support arm thereby being adapted to take up forces in a direction transversely to the frame.

5. The radiator module according to claim 4, wherein the at least one support arm has an adjustable length.

6. The radiator module according to claim 4, wherein the at least one support arm is attached to the frame via a hinge connection.

7. The radiator module according to claim 1, wherein the frame is further provided with at least one interface part being adapted to form a frame-to-frame connection to an adjacent radiator module according to any of the preceding claims.

8. The radiator module according to claim 7, wherein the at least one frame interface part is configured for attachment to any of the at least two predefined attachment positions.

9. The radiator module according to claim 1, wherein the radiator module comprises at least two radiator elements and fluid connections for fluidly interconnecting the at least two radiator elements.

10. A conditioning system for a wind turbine, the conditioning system comprising at least one radiator module according to claim 1.

11. The conditioning system according to claim 10, wherein the conditioning system comprises at least two radiator modules, and wherein the radiator elements of the at least two radiator modules are fluidly coupled to each other.

12. A method for configuring a radiator of a conditioning system for a wind turbine with a nacelle defining structural support points for the radiator, the method comprising the steps of:
defining thermal requirements of the radiator,
based on the defined thermal requirements, defining a number of radiator elements and a number of radiator modules according to claim 1 necessary in order to meet the defined thermal requirements,
providing, as defined, at least one radiator element and at least one radiator module,
configuring the at least one radiator module by performing the steps of:
selectively attaching a mounting element to each selected attachment position, selected among the at least two predefined attachment positions, where the selected attachment positions match positions of structural support points of the nacelle, and
mounting at least one radiator element on the provided radiator modules, and
mounting the at least one radiator module on the nacelle of the wind turbine by attaching the at least one mounting element to the corresponding structural support points of the nacelle.

13. The method according to claim 12, wherein each mounting element comprises a leg with an adjustable length being adapted to be connected to the structural support points of the nacelle of the wind turbine, and wherein the method further comprises the step of adjusting the length of each leg in accordance with the position of the corresponding structural support point of the nacelle.

14. The method according to claim 12, wherein the at least one radiator module comprises at least one support arm, each establishing a support connection between the radiator module and the wind turbine, wherein the frame is provided with at least two predefined support positions, each being adapted to have a support arm attached thereto, wherein the method further comprises mounting the at least one support arm at one of the at least two predefined support positions and at a connection position at a structural support point of the nacelle, the connection position being arranged at a distance in front of or behind the frame, the at least one support arm thereby extending along a direction forming an angle relative to the frame, the support arm thereby being adapted to take up forces in a direction transversely to the frame.

15. The method according to claim 12, wherein the step of providing at least one radiator module comprises providing at least two radiator modules, and wherein the method further comprises the step of forming frame-to-frame connections between the at least two radiator modules via at least one interface part formed on the frames of the at least two radiator modules.

16. The wind turbine comprising at least one radiator module according to claim 1.
